(19) United States
(12) Patent Application Publication
(10) Pub. No.: US 2008/0084389 A1
(43) Pub. Date: Apr. 10, 2008

(54) Handheld electronic apparatus with functions of intelligent remote control

(76) Inventor: Su-Cheong Mac, Sijhih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/651,980

(22) Filed: Jan. 11, 2007

(30) Foreign Application Priority Data
Oct. 5, 2006 (TW) 095137192

(51) Int. Cl. G09G 5/08

(52) U.S. Cl. 345/158

(57) ABSTRACT

A handheld electronic apparatus is disclosed. The apparatus includes a plurality of buttons, a wireless signal transmission unit, a processor and a storage unit. Each button with a display device for showing an icon corresponding to one of operation functions is provided for a user to select from operation functions. The wireless signal transmission unit is used to transmit the wireless signal of the selected operation function to a remote electronic apparatus for control. An operation habit of the user is recorded by the processor based on a criterion and saved in the storage unit. The operation functions are divided into at least two groups by the processor based on the operation habit, and the processor drives the display devices to highlight the corresponding icons of one of the groups.

### FIELD OF THE INVENTION

The present invention relates to a handheld electronic apparatus, and more particularly to a handheld electronic apparatus that records operation habits of users and highlights frequently used icons with functions of intelligent remote control.

### BACKGROUND OF THE INVENTION

At present, remote controller become a necessary electronic apparatus for our daily life, and most electronic appliances including televisions, stereos and DVD players come with a remote controller for users to control the electronic appliances. More electronic apparatuses introduced to the market result in more remote controllers, and it thus makes the management of remote controllers quite difficult. In addition, the functions of electronic products become increasingly powerful, and the interface of the remote controller also becomes increasingly more complicated, and it thus causes inconvenience to the use of remote controllers. Furthermore, users have their own habits. For instance, grandfathers often use a remote controller to switch channels for watching TV, and parents often use a remote controller to operate the play, fast forward, or select function of a DVD player for watching video. Youngsters can accept high technologies faster and better than the elderly, and thus youngsters can learn how to use the more complicated functions of a remote controller, such as pre-recording a ball game. However, not all users know how to operate the complicated remote controllers.

In view of the shortcomings of the prior art, the inventor of the present invention based on years of experience on the related industry to conduct researches and experiments, and finally developed a handheld electronic apparatus with functions of intelligent remote control to overcome the shortcomings of the prior art.

### SUMMARY OF THE INVENTION

Therefore, it is a primary objective of the present invention to provide a handheld electronic apparatus to improve the convenience of operating a remote electronic apparatus.

To achieve the foregoing objective, the present invention discloses a handheld electronic apparatus comprising a plurality of buttons, a wireless signal transmission unit, a processor and a storage unit. Each button has a display device for showing an icon corresponding to one of the plurality of operation functions and providing the icon for users to select from the operation functions. The wireless signal transmission unit transmits a wireless signal corresponding to the selected operation function to a remote electronic apparatus to control the remote electronic apparatus. The processor records an operation habit of a user based on a criterion and saves the operation habit into the storage unit. The processor divides the operation functions into at least two groups based on the operation habit and drives the display devices to highlight display of icons corresponding to a desired group selected from the at least two groups.

The present invention further discloses a handheld electronic apparatus comprising a touch screen, a wireless signal transmission unit, a processor and a storage unit. The touch screen is provided for displaying a plurality of icons corresponding to a plurality of operation functions and providing the icons for users to select from the operation functions. The wireless signal transmission unit transmits a wireless signal corresponding to the selected operation functions to a remote electronic apparatus to control the remote electronic apparatus. The processor records an operation habit of a user based on a criterion and saves the operation habit in the storage unit. The processor divides the operation functions into at least two groups based on the operation habit and drives the touch screen to highlight display of icons corresponding to a desired group selected from the at least two groups.

According to the objective of the present invention, the highlighted icons of the corresponding desired group are icons with frequently used functions. The color, size and brightness of the frequently used icons and the position of displayed buttons are used for distinguishing the seldom used icons, or only the frequently used icons are shown and the seldom used icons are hidden.

According to the objective of the present invention, the processor is provided for recording the operation habits of different users, such that different users can achieve the personalized control effect of a single handheld electronic apparatus.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 is a schematic view of a handheld electronic apparatus in accordance with an embodiment of the present invention;

FIG. 2a is a schematic view of an example of a highlight display in accordance with the present invention;

FIG. 2b is a schematic view of another example of a highlight display in accordance with the present invention;

FIG. 2c is a schematic view of a further example of a highlight display in accordance with the present invention;

FIG. 3 is a schematic view of a handheld electronic apparatus in accordance with another embodiment of the present invention;

FIG. 4 is a schematic view of a touch screen in accordance with another embodiment of the present invention;

FIG. 5a is a schematic view of an example of a highlight display; and

FIG. 5b is a schematic view of another example of a highlight display.

### DETAILED DESCRIPTION OF THE PREFERRED EMBODIMENTS

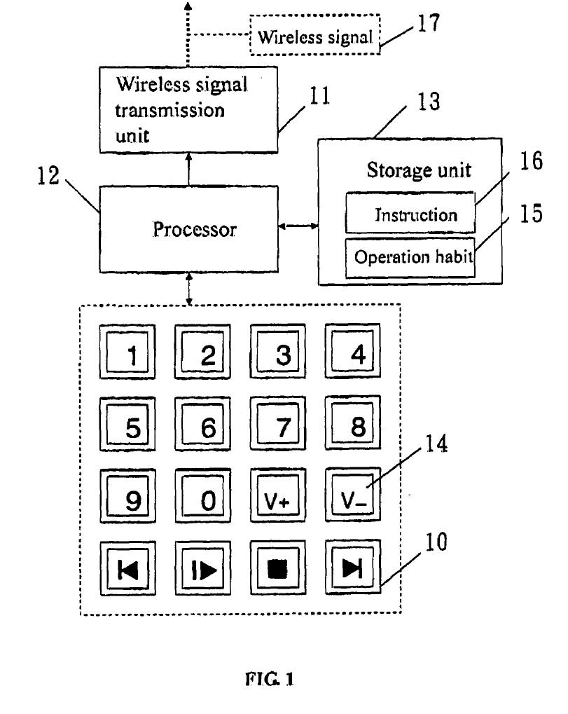

The handheld electronic apparatus of the present invention will now be described in more detail hereinafter with reference to the accompanying drawings that show various embodiment of the invention. In the following embodiments, same numerals are used to indicate same elements. Referring to FIG. 1 for a schematic view of a handheld electronic apparatus in accordance with an embodiment of the present invention, the handheld electronic apparatus 1 comprises a plurality of buttons 10, a wireless signal transmission unit 11, a processor 12 and a storage unit 13. Each button 10 has a display device 14 for showing an icon corresponding to one of a plurality of operation functions. In FIG. 1, 16 buttons are shown for 16 functions of a DVD player, and these buttons arranged from left to right and up to down with Number 1, Number 2, Number 3, Number 4, Number 5, Number 6, Number 7, Number 8, Number 9, Number 0, Volume Up, Volume Down, Previous, Play/Pause, Stop and Next. These buttons 10 are provided for users to select the operation functions. If a user presses one of the buttons 10, a trigger signal will be generated, such that after the processor 12 receives the trigger signal, an instruction 16 of an operation function corresponding to the pressed button will be read from the storage unit 13 and sent to the wireless signal transmission unit 11. The wireless signal transmission unit 11 will convert the instruction 16 into a wireless signal 17 and transmit the wireless signal 17 to a remote electronic apparatus for controlling the remote electronic apparatus.

In addition, the processor 12 records an operation habit 15 of a user based on a criterion and saves the operation habit 15 in the storage unit 13, and the processor 12 divides the operation functions into at least two groups. For example, the operation functions are divided into a group of frequently used operation functions and a group of seldom used operation functions. The processor 12 counts the number of times of selecting each operation function; if the number of times of selecting a certain operation function exceeds a threshold, then the operation function is categorized as a frequently used operation function, or else the operation function is categorized as a seldom used operation function. Alternatively, the processor can count the time interval of selecting each operation function; if the time interval of selecting a certain operation function exceeds a time interval threshold such as a week, indicating that the operation function has not been selected by users for over one week, then the operation function is categorized as a seldom used operation function, or else the operation function is categorized as a frequently used operation function.

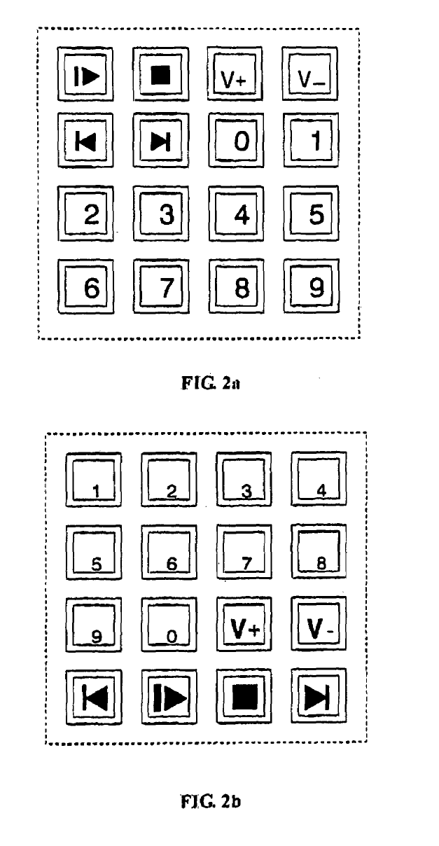

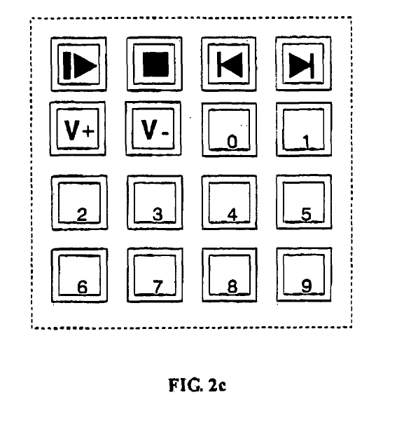

After the processor 12 divides the operation functions into groups based on the operation habit, the processor 12 drives the display device 14 to highlight a display of icons corresponding to a desired group. For example, a change of color of the icons corresponding to a group of frequently used operation functions, a displayed button position, a change of ratio of the size of the icons corresponding to a group of frequently used operation functions to the size of the icons corresponding to another group, a change of ratio of the brightness of the icons corresponding to the desired group to the brightness of the icons corresponding to another group, or simply displaying the icons corresponding to a group of operation functions but hiding the icons corresponding to another group. Therefore, the invention can improve the convenience of use and allow users to select and operate the functions of the handheld apparatus easily. Referring to FIGS. 2a to 2c for schematic views of examples of a highlight display in accordance with the present invention, the frequently used operation functions include Play/Pause, Stop, Volume Up, Volume Down , Previous and Next. In FIG. 2a, the positions of buttons for the frequently used operation functions are arranged in the front to facilitate users to select the buttons. In FIG. 2b, the icons for the frequently used operation functions are enlarged and the icons for the seldom used operation functions are reduced, such that the ratio of the size of icons for frequently used operation functions to the size of icons for seldom used operation functions is changed to facilitate users to select the buttons. In FIG. 2c, the highlight display simultaneously changes the positions of the buttons and the ratio of the size of icons for frequently used operation functions to the size of icons for seldom used operation functions.

In addition, the handheld electronic apparatus 1 can install an identification device as needed for identifying different users, and the storage unit 13 is provided for storing identification information corresponding to different users. The identification device is preferably a fingerprint identification device, a password identification device or a voice identification device. After different users are identified, the processor 12 keeps recording the operating habits of different users, so that the handheld electronic apparatus 1 can provide a personal control on different users.

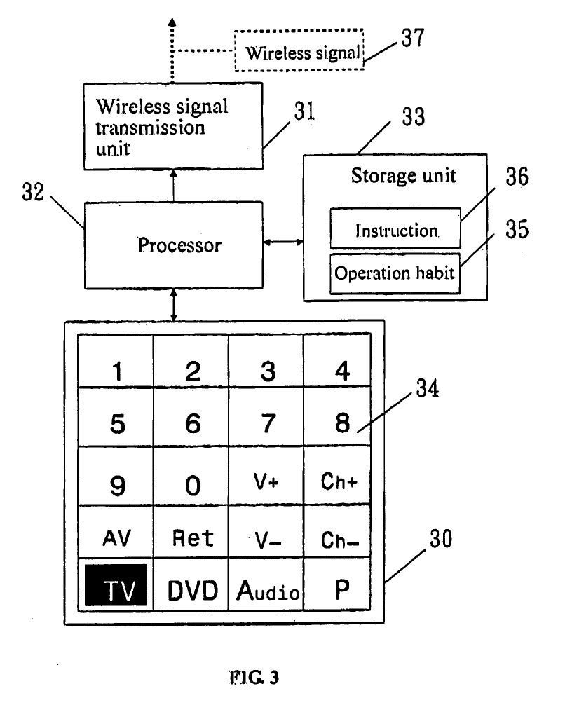

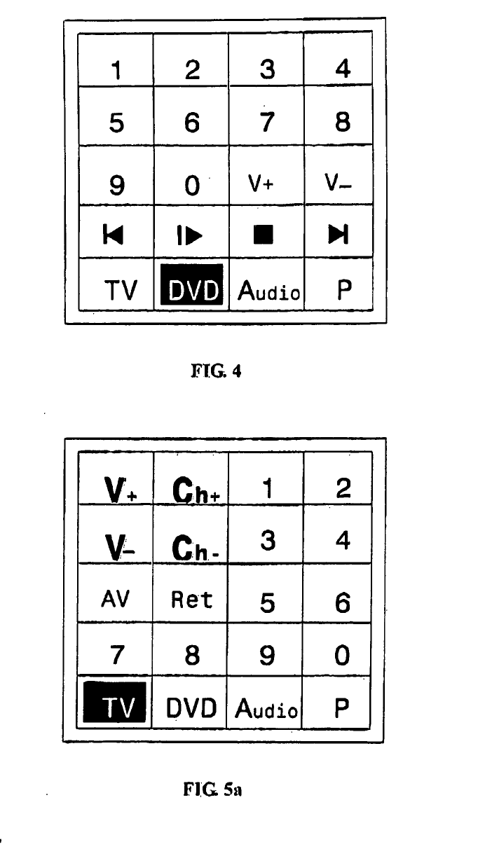

Referring to FIG. 3 for a schematic view of a handheld electronic apparatus in accordance with another preferred embodiment of the present invention, the handheld electronic apparatus 3 comprises a touch screen 30, a wireless signal transmission unit 31, a processor 32 and a storage unit 33. The touch screen 30 displays a plurality of icons corresponding to a plurality of operation functions in a plurality of areas 34 and provided for users to select from the operation functions. In FIG. 3, the operation functions include Number 1, Number 2, Number 3, Number 4, Number 5, Number 6, Number 7, Number 8, Number 9, Number 0, Volume Up, Next Frequency Channel, Audio/Video Switch, Frequency Channel Recovery, Volume Down, Previous Frequency Channel, TV Function Switch, DVD Function Switch, Music Function Switch and Personal Function Switch. Sixteen icons appear on the touch screen 30 as shown in FIG. 3 are provided for television functions and the 16 icons appear on the touch screen 30 as shown in FIG. 4 are provided for DVD functions, and users can select from the areas of a television function switch, a DVD function switch, a music function switch and a personal function switch. If a user presses a certain area, the touch screen 30 will send the position data corresponding to the pressed area to the processor 32, and the processor 32 will read an instruction 36 of the currently shown operation function corresponding to the pressed area based on the position data from the storage unit 33 and send the instruction 36 to the wireless signal transmission unit 31. The wireless signal transmission unit 31 converts the instruction 36 into a wireless signal 37 and sends the wireless signal 37 to the remote electronic apparatus to control the remote electronic apparatus.

In addition, the processor 32 records an operation habit 35 of a user based on a criterion and saves the operation habit 35 in the storage unit 33, and the processor 32 divides the operation functions into at least two groups based on the operation habit 35. For example, the operation functions can be divided into a group of frequently used operation functions and a group of seldom used operation functions. The processor 32 counts the number of times of selecting each operation function; if the number of times of selecting each operation function exceeds a threshold, then the operation function is categorized as a frequently used operation function, or else the operation function is categorized as a seldom used operation function. Alternatively, the processor can count the time interval of selecting each operation function; if the time interval of selecting a certain operation function exceeds a threshold such as a week, indicating that the operation function has not been selected by users for over one week, then the operation function is categorized as a seldom used operation function, or else the operation function is categorized as a frequently used operation function.

After the processor 32 divides the operation functions into groups based on the operation habit, the processor 32 drives the touch screen 30 to highlight a display of icons corresponding to a desired group. For example, a change of color of the icons corresponding to a group of frequently used operation functions, a displayed button position, a change of ratio of the size of the icons corresponding to a group of frequently used operation functions to the size of the icons corresponding to another group, a change of ratio of the brightness of the icons corresponding to the group of frequently used operation functions to the brightness of the icons corresponding to another group, or simply displaying the icons corresponding to a group of frequently used operation functions but hiding the icons corresponding to another group. Therefore, the invention can improve the convenience of use and allow users to select and operate the functions of the handheld apparatus easily.

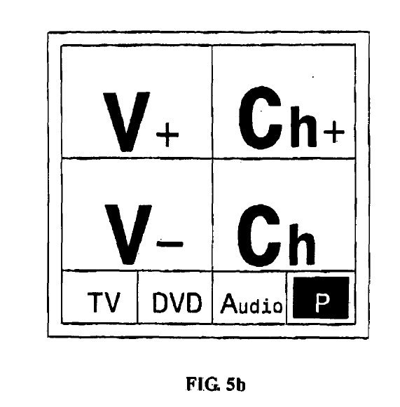

Referring to FIG. 5a for a schematic view of an example of a highlight display of the present invention, the frequently used operation functions include Next Frequency Channel, Previous Frequency Channel, Volume Up and Volume Down. In FIG. 5a, the positions of buttons for frequently used operation functions are arranged in the front and the respective icons are enlarged to facilitate users to select. In addition, the handheld electronic apparatus 3 also drives the touch screen 30 to show icons for the frequently used operation functions only and hide the icons corresponding to other groups, and rearrange the icon display area. In FIG. 5b, if a user presses a personal function switch area, then the touch screen 30 will show the common functions including Next Frequency Channel, Previous Frequency Channel, Volume Up and Volume Down and rearrange the icon display area. The icons are highlighted to fit the poor eyesight of the elderly, and thus such arrangement enhances the convenience of the operation greatly. If the user uses another operation function, then the user can press TV function area, DVD function area, or music function area to display all functions as shown in FIGS. 3 and 4.

In addition, the handheld electronic apparatus 3 can install an identification device as needed for identifying different users, and the storage unit 33 is provided for storing identification information corresponding to different users. The identification device is preferably a fingerprint identification device, a password identification device or a voice identification device. After different users are identified, the processor 32 keeps recording the operating habits of different users, so that the handheld electronic apparatus 3 can provide personalized control for different users.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A handheld electronic apparatus, for controlling a remote electronic apparatus, and said handheld electronic apparatus comprising:
a plurality of buttons, each having a display device for displaying an icon corresponding to one of a plurality of operation functions and provided for a user to select from said operation functions;
a wireless signal transmission unit, for transmitting a wireless signal corresponding to said selected operation function to said remote electronic apparatus for controlling said remote electronic apparatus; and
a processor, for recording an operation habit of a user based on a criterion;
a storage unit, for storing said operation habit;
wherein said processor divides said operation functions into at least two groups based on said operation habit and drives said display devices to highlight corresponding icons of a desired group selected from said at least two groups.

2. The handheld electronic apparatus of claim 1, wherein said highlighted display includes a change of color or displayed button position of said icons of the desired group, a change of ratio of the size of said icons corresponding to the desired group to the size of said icons corresponding to another group, a change of ratio of the brightness of said icons corresponding to the desired group to the brightness of said icons corresponding to another group, or simply displaying said icons corresponding to the desired group but hiding said icons corresponding to the other group.

3. The handheld electronic apparatus of claim 1, wherein said processor divides said operation functions into a group of frequently used operation functions and a group of seldom used operation functions.

4. The handheld electronic apparatus of claim 3, wherein said criterion is to count the number of times of selecting each of said operation functions; if the number of selecting said operation function exceeds a threshold, then said operation function is categorized as a frequently used operation function, or else said operation function is categorized as a seldom used operation function.

5. The handheld electronic apparatus of claim 3, wherein said criterion is to count the time interval of selecting each of said operation functions; if the time interval of selecting said operation function exceeds a threshold, said operation function is categorized as a seldom used operation function, or else said operation function is categorized as a frequently used operation functions.

6. The handheld electronic apparatus of claim 1, further comprising an identification device for identifying different users, and said storage unit is provided for storing identification information of different users.

7. The handheld electronic apparatus of claim 6, wherein said processor records operation habits of different users.

8. The handheld electronic apparatus of claim 6, wherein said identification device is a fingerprint identification device, a password identification device or a voice identification device.

9. A handheld electronic apparatus, for controlling a remote electronic apparatus, and said handheld electronic apparatus comprising:
a touch screen, for showing a plurality of icons corresponding to a plurality of operation functions and providing said icons for a user to select from said operation functions;
a wireless signal transmission unit, for transmitting a wireless signal corresponding to said selected operation function to said remote electronic apparatus for controlling said remote electronic apparatus;
a processor, for recording an operation habit of a user based on a criterion;
a storage unit, for storing said operation habit;
thereby, said processor divides said operation functions into at least two groups based on said operation habit and drives said touch screen to highlight corresponding icons of a desired group selected from said at least two groups.

10. The handheld electronic apparatus of claim 9, wherein said highlighted display includes a change of color or displayed position of said icons of the desired group, a change of ratio of the size of said icons corresponding to the desired group to the size of said icons corresponding to another group, a change of ratio of the brightness of said icons corresponding to the desired group to the brightness of said icons corresponding to another group, or simply displaying said icons corresponding to the desired group but hiding said icons corresponding to the other group.

11. The handheld electronic apparatus of claim 9, wherein said processor divides said operation functions into a group of frequently used operation functions and a group of seldom used operation functions.

12. The handheld electronic apparatus of claim 11, wherein said criterion is to count the number of times of selecting each of said operation functions; if the selected number of operation functions exceeds a threshold, then said operation function is categorized as a frequently used operation function, or else said operation function is categorized as a seldom used operation function.

13. The handheld electronic apparatus of claim 1, wherein said criterion is to count the time interval of selecting each of said operation functions; if the time interval of selecting said operation function exceeds a threshold, said operation function is categorized as a seldom used operation function, or else said operation function is categorized as a frequently used operation functions.

14. The handheld electronic apparatus of claim 9, further comprising an identification device for identifying different users, and said storage unit is provided for storing identification information corresponding to different users.

15. The handheld electronic apparatus of claim 14, wherein said processor records operation habits of different users.

16. The handheld electronic apparatus of claim 14, wherein said identification device is a fingerprint identification device, a password identification device or a voice identification device.
